(19) United States
(12) Patent Application Publication
(10) Pub. No.: US 2026/0088625 A1
(43) Pub. Date: Mar. 26, 2026

(54) ENERGY MANAGEMENT PLATFORM

(71) Applicant: QSecGrid, Inc., New York, NY (US)

(72) Inventors: Gordon R. WINSTON, Katonah, NY (US); John-Philip GALINSKI, Forest Hills, NY (US); Nigel WALKER, Ponteland (GB); Mark THOMPSON, Blyth (GB); Patrick J.D. SANTOS, Kirkland, WA (US)

(21) Appl. No.: 19/274,186

(22) Filed: Jul. 18, 2025

Related U.S. Application Data
(60) Provisional application No. 63/699,116, filed on Sep. 25, 2024.

(51) Int. Cl. H02J 3/38; H02J 3/00

(52) U.S. Cl. CPC H02J 3/38; H02J 3/0012

(57) ABSTRACT

An energy management platform may include at least one energy profile manager configured to receive one or more energy records of one or more energies from one or more energy sources. The energy management platform may further include at least one energy analysis engine configured to analyze one or more energy-related attributes corresponding to the one or more received energy records by the at least one energy profile manager. The management platform may further include an allocation manager configured to detect at least one business rule associated with one or more energy allocation requirements of at least one entity. The allocation manager may further be configured to allocate the one or more energies corresponding to the one or more received energy records in accordance with the at least one detected business rule.

### RELATED APPLICATION

This application claims priority to a commonly owned, U.S. Provisional Patent Application No. 63/699,116 , filed on Sep. 25, 2024, and titled “Predictive Energy Management”, which is herein incorporated by reference in its entirety.

### TECHNICAL FIELD

Embodiments of the present invention generally relate to managing energies and more particularly to management of energies using an energy management platform.

### BACKGROUND

Energy is a fundamental resource used for most of the activities ranging from communications, powering homes, fueling industries, transportation, food preparation, and so forth. In the case of commercial, industrial, or business operations, energy is used for the production or manufacturing of goods or providing services. Despite its importance, however, energy management often falls short, leading to inefficiencies, losses during transmission and distribution of energies such as from a power grid to an end user, higher costs, lack of real-time data monitoring, encouraging consumers with incentives for sharing unconsumed energies or generated energies, etc.

There is thus a need for a system and method for accounting energies in a more efficient and/or effective manner.

### BRIEF DESCRIPTION OF THE DRAWINGS

Features and advantages of embodiments of the present invention will become apparent upon consideration of the following detailed description of embodiments thereof, especially when taken in conjunction with the accompanying drawings, and wherein:

FIG. 1 is a block diagram depicting an exemplary computing environment that facilitates management of energies in accordance with at least one embodiment of the present invention.

FIG. 2 is an exemplary functional block diagram of components of an energy management platform in accordance with at least one embodiment of the present invention.

FIG. 3 is an exemplary block diagram of a user interface of an energy management application in accordance with at least one embodiment of the present invention.

FIG. 4 is an exemplary block diagram of a control panel of an energy management application in accordance with at least one embodiment of the present invention.

FIG. 5 is an exemplary process of allocating energies using an energy management platform in accordance with at least one embodiment of the present invention.

FIG. 6 is an exemplary process of overriding an energy allocation using an energy management platform in accordance with at least one embodiment of the present invention.

FIG. 7 is an exemplary process of detecting an anomaly in an energy allocation using an energy management platform in accordance with at least one embodiment of the present invention.

FIG. 8 is an exemplary process of allocation of energies based on a prioritization policy using an energy management platform in accordance with at least one embodiment of the present invention.

FIG. 9 is an exemplary process of generating a billing product using an energy management platform in accordance with at least one embodiment of the present invention.

FIG. 10 is a schematic diagram illustrating aspects of an example computer in accordance with at least one embodiment of the present invention.

The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include”, “including”, “includes”, “such as”, “for instance”, and “for example” mean “including but not limited to”. To facilitate understanding, like reference numerals have been used, where possible, to designate like elements common to the figures. Optional portions of the figures may be illustrated using dashed or dotted lines, unless the context of usage indicates otherwise.

### DETAILED DESCRIPTION

An energy accounting system may include at least one energy profile manager configured to receive energy records of one or more energies from one or more energy sources. The energy accounting system may further include at least one energy analysis engine configured to analyze one or more energy-related attributes corresponding to the one or more energy records received by the at least one energy profile manager. The energy accounting system may further include an allocation manager configured to detect at least one business rule associated with one or more energy allocation requirements of at least one entity. The allocation manager may further be configured to allocate the one or more energies corresponding to the one or more received energy records in accordance with the at least one detected business rule.

A method for managing one or more energies using an energy management platform may include receiving energy records of the one or more energies from one or more energy sources. The method may further include analyzing one or more energy-related attributes corresponding to the one or more received energy records. The method may further include detecting at least one business rule associated with one or more energy allocation requirements of at least one entity. The method may further include allocating the one or more energies corresponding to the one or more received energy records in accordance with the at least one detected business rule.

One or more computer-readable storage media collectively having thereon computer-executable instructions that, when executed, collectively cause one or more computers to, at least: receive one or more energy records of one or more energies from one or more energy sources. The computer-readable storage media may further cause the one or more computers to analyze one or more energy-related attributes corresponding to the one or more received energy records. The computer-readable storage media may further cause the one or more computers to detect at least one business rule associated with one or more energy allocation requirements of at least one entity. The computer-readable storage media may further cause the one or more computers to allocate the one or more energies corresponding to the one or more received energy records in accordance with the at least one detected business rule.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a”(or “an”), “one or more”and “at least one”can be used interchangeably herein.

The term “automatic” and variations thereof, as used herein, refers to any suitable process or operation done independent of material human input when the process or operation may be performed. However, a process or operation can be automatic, even though performance of the process or operation uses material or immaterial human input, if the input may be received before performance of the process or operation. Human input may be deemed to be material if such input influences how the process or operation will be performed. Human input that consents to the performance of the process or operation may not be deemed to be “material.”

The term “determine” and variations thereof, as used herein, may include any suitable type of methodology, process, operation, and/or technique. Such determinations may include calculations and/or computations.

The term “energy management platform user” and variations thereof, as used herein, may be defined as a person or an entity that engages with an energy management platform to perform functions such as viewing, managing, or analyzing energy transactions, generating reports, and/or facilitating energy trading. The energy management platform user may interact with the energy management platform through a user interface, and the interactions may be logged for audit and compliance purposes.

The term “energy management platform administrator” and variations thereof, as used herein, may be defined as a person or an entity that may have advanced access rights within the energy management platform. The energy management platform administrator may be responsible for tasks such as configuring system settings, managing user accounts and permissions, enabling data integrity, overseeing compliance with regulatory requirements, and maintaining overall system security. The energy management platform administrator may have an ability to audit transactions, modify system parameters, and troubleshoot technical issues. The actions performed by the energy management platform administrator may be logged in the energy management platform for tracking and energy compliance purposes.

The term “energies” and variations thereof, as used herein, may be defined as various forms of energy, including electrical energy generated from renewable and non-renewable energy sources. The energies may be categorized based on their energy provenance of generation, such as solar, wind, hydro, fossil fuel, or nuclear, and may be tracked, managed, and traded within the energy management platform.

The term “energy source” and variations thereof, as used herein, may be defined as an entity or mechanism capable of and/or responsible for generating or supplying energy. The energy source may include renewable energy sources such as solar panels, wind turbines, and hydroelectric plants, or non-renewable energy sources such as fossil fuel-based generators and nuclear power plants, as well as energy storage devices and facilities such as batteries.

The term “energy consumer” and variations thereof, as used herein, may be defined as an entity, machine, device or mechanism that consumes and/or dissipates energy. At times, the term may be used to reference a responsible person or entity that utilizes or draws energy. Examples of the energy consumers may include an individual, a business, a utility company, or a grid operator. Each energy consumer may be associated with an energy profile.

The term “energy storage facilities” and variations thereof, as used herein, may be defined as infrastructure, systems, or energy-associated machines that may be capable of storing energy. The energy storage facilities may function both as energy consumers and energy sources, dynamically shifting roles as needed based on one or more demands, supply conditions, grid requirements, and so forth.

The term “energy records” and variations thereof, as used herein, is defined as data associated with energy, such as data associated with energy consumption, energy generation, energy distribution, energy transactions, energy allocations, and energy associated metadata. The energy records may be obtained from energy-related entities, energy-related accounting ledgers, audit logs, energy-related monitoring systems, smart energy meters, energy-related sensors, energy grids, energy-related blockchain networks, energy-related utility providers, energy-related regulatory bodies, or any other energy-related system or energy source capable of tracking, recording, categorizing and/or managing the energy records. At some instances, the energy records may correspond to the energy itself, the entity associated with the energy, and/or any parameters relevant to management of the energy within an energy management platform.

The term “energy-related attributes” and variations thereof, as used herein, is defined as distinguishing characteristics or properties of energy sources or energy provenances. The energy-related attributes may include a type of energy (e.g., renewable or non-renewable), a provenance of energy, a quantity of energy, an energy efficiency rating, an energy source type, a carbon impact, other relevant parameters that may be used for distinguishing and reporting the energies in the energy management platform.

The term “energy provenance” and variations thereof, as used herein, may be defined as a documented history or origin of energies, including details about how and where energies were generated, stored, transmitted, and/or consumed. The energy provenance may enable a traceability and/or an accountability in energy transactions and may be used to authenticate energy sources, contributing to sustainability and compliance reporting.

The term “energy characterization” and variations thereof, as used herein, may be defined as a process of describing or defining specific energy-related attributes of energy. Energy characterization may enable the energy-related attributes to be correctly represented and utilized in the energy management platform.

The term “energy compliances” and variations thereof, as used herein, may be defined as a recognized set of guidelines, rules, or metrics used for validating energy transactions and energy compliances related to energy-related transactions including government regulations and industry guidelines.

The term “energy standards” and variations thereof, as used herein, may be defined as domestic and/or international energy standards, accounting related energy standards, jurisdictional energy guidelines, and so forth.

The term “energy aggregation” and variations thereof, as used herein, may be defined as a process of combining multiple energies or quantities of energies from one or more energy sources into a unified dataset. The energy aggregation may allow for consolidated reporting and analysis of energy flows and may be utilized in the energy management platform to manage large volumes of energy data efficiently. Aggregation operations may include collection, partitioning, provisioning, allocation, grouping, and/or clustering operations.

The term “energy reaggregation” and variations thereof, as used herein, may be defined as a process of recombining previously disaggregated or separated energies or quantities of energies into a new, structured dataset. The energy reaggregation may occur for purposes such as recalculating energy balances, updating records in a general ledger, or preparing data for reporting in energy compliance with updated energy standards or requirements. Reaggregation operations may include collection, partitioning, provisioning, allocation, grouping, and/or clustering operations.

The term “energy disaggregation” and variations thereof, as used herein, may be defined as a process of breaking down aggregated energies or quantities of energies into their component parts. The energy disaggregation may provide detailed insights into individual transactions, source-specific energy contributions, and energy-related attributes, facilitating more granular analysis and reporting in the energy management platform. Disaggregation operations may include collection, partitioning, provisioning, allocation, grouping, and/or clustering operations.

The term “chain of custody” and variations thereof, as used herein, may be defined as a process that enables traceability, accountability, and integrity of energies from their point of origin through to their final destination or consumption. The chain of custody may involve maintaining a transparent and verifiable record of one or more stages of energy's lifecycle, which may include energy generation, energy aggregation, energy storage, energy distribution, energy consumption, energy re-aggregation, energy de-aggregation, and so forth.

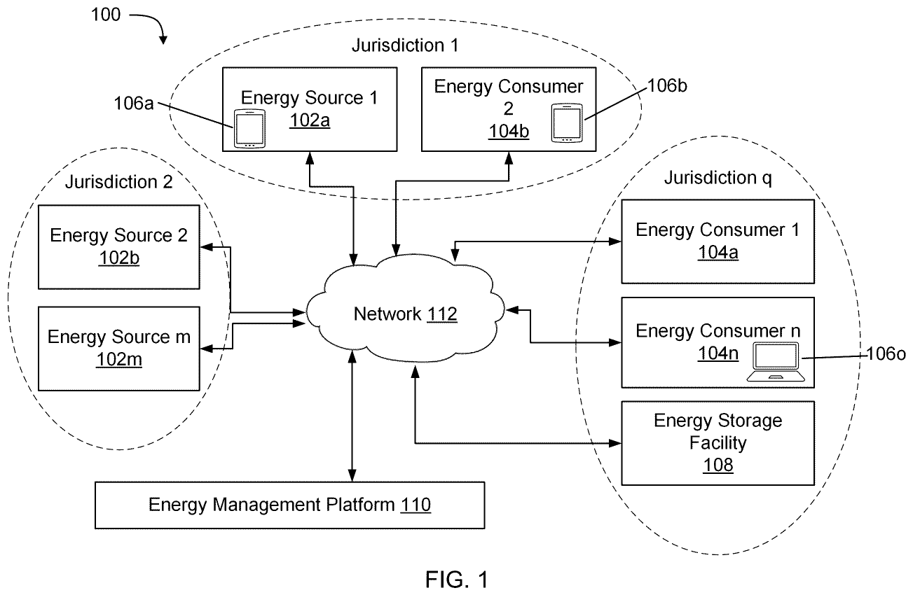

FIG. 1 may be a block diagram depicting an exemplary computing environment 100 for accounting energies, according to at least one embodiment of the present invention. The computing environment 100 may be capable of managing, organizing, and certifying energy-related transactions among one or more entities.

The energy-related transactions among the one or more entities may be, for example, an energy generation (i.e., an internal an/or an external), an energy consumption, an energy transfer, energy storage updates including charging and discharging of an energy storage facility, an energy lending, an energy borrowing, an energy balancing, energy trading activities, energy reconciliation, and so forth. Embodiments of the present invention are intended to include or otherwise cover any suitable type of the energy-related transactions, including known, related art, and/or later developed technologies.

The one or more entities may be individuals, companies, government agencies, and/or organizations involved in energy production, energy distribution, energy storage, energy consumption, and so forth. The one or more entities may operate within a localized area, across multiple regions, disseminated regions, and so forth. Embodiments of the present invention are intended to include or otherwise cover any suitable type of operative regions, including known, related art, and/or later developed technologies.

In an embodiment of the present invention, the one or more entities may include a plurality of energy sources 102a-102m (hereinafter referred to as “energy sources 102” or “energy source 102”). The energy sources 102 may be renewable energy sources such as solar panels, wind turbines, and hydropower stations; non-renewable energy sources such as natural gas plants, coal mines, and nuclear power plants; energy storage systems such as batteries or pumped hydro storage; Distributed Energy Resources (DERs) such as power grids, microgrids or localized generators; and external energy markets or third-party suppliers, in an embodiment of the present invention. The energy sources 102 may also include hybrid systems that combine multiple energy generation technologies, in another embodiment of the present invention. Embodiments of the present invention are intended to include or otherwise cover any suitable type of the energy source 102, including known, related art, and/or later developed technologies that may be beneficial to generate the energies.

In an embodiment of the present invention, some or all energy sources 102 may be located in geographically separate jurisdictions, which may be spread across different regions, countries, continents, and so forth. The energy sources 102 may operate independently and/or be interconnected via communication networks. The computing environment 100 may be configured to manage a coordination of the geographically separated energy sources 102 to enable an effective and/or efficient energy generation, storage, and distribution while adhering to local regulations and optimizing the use of energy resources across different regions.

As energy sources 102 can be configured as DERs, they can also be configured as intelligent DERS (IDERs) which provide APIs to serve operational telemetry, and to be remotely controlled. Accordingly, energy sources 102 configured as IDERs can provide operational telemetry reporting the status and performance over time of the respective energy source 102 which in turn may be used by the energy management system in concert with other data to analyze energy performance and to make recommendations.

Further, the one or more entities may include a plurality of energy consumers 104a-104n (hereinafter referred to as “energy consumer 104” or “energy consumers 104”). The energy consumers 104 may be residential users, commercial establishments, industrial facilities, electric vehicle charging stations, and utility companies, in an embodiment of the present invention. The energy consumers 104 may also include energy brokers, energy storage systems, and microgrid operators that consume, store, or redistribute energy, in another embodiment of the present invention. Additionally, the energy consumers 104 may involve entities that participate in energy lending, energy borrowing, or trading markets, as well as those who seek to optimize their energy usage based on sustainability goals, in yet another embodiment of the present invention.

In an embodiment of the present invention, some or all energy consumers 104 may be located in geographically separate jurisdictions, which may be spread across different regions, countries, continents, and so forth. The energy consumers 104 may operate independently and/or be interconnected via communication networks. The energy consumers 104 may be configured to manage coordination of the geographically separated energy consumers 104 to enable an effective and/or efficient energy generation, storage, and distribution while adhering to local regulations and optimizing the use of energy resources across different regions. Embodiments of the present invention may be intended to include or otherwise cover any suitable energy consumers 104.

In an embodiment of the present invention, the energy consumers 104 may be having one or more energy-associated machines, that may be heat pumps, Heating, Ventilation, and Air Conditioning (HVAC) systems, electrical appliances, such as refrigerators, washing machines, dishwashers, ovens, and microwaves; generators, electric vehicles, battery storage systems, lighting systems such as Light Emitting Diode (LED) lights, streetlights, and emergency lighting; air conditioners, water heaters, industrial machinery, such as conveyor belts, pumps, and compressors; automated manufacturing equipment, data centers, computers, mobile phones, smart gadgets, servers, processors, smart home devices, such as thermostats, smart plugs, and security systems; agricultural equipment, such as irrigation pumps and greenhouse climate control systems; electric forklifts, electric-powered construction tools, electric motors in various applications, and so forth. Embodiments of the present invention may be intended to include or otherwise cover any suitable type of the energy-associated machines, including known, related art, and/or later developed technologies.

In an embodiment of the present invention, the energy consumers 104 may be owners, users, or operators of the one or more energy-associated machines. The energy consumers 104 may have one or more user devices 106a-106o (hereinafter referred to as “user devices 106”). The user devices 106 may enable the energy consumers 104 to interact within the computing environment 100. The user devices 106 may be for example smartphones, tablets, laptops, desktop computers, displays, screens, smart watches, smart speakers, smart thermostats, Internet-of-Things (IoT)-enabled devices, and so forth. Embodiments of the present invention may be intended to include or otherwise cover any suitable type of user device 106, including known, related art, and/or later developed technologies.

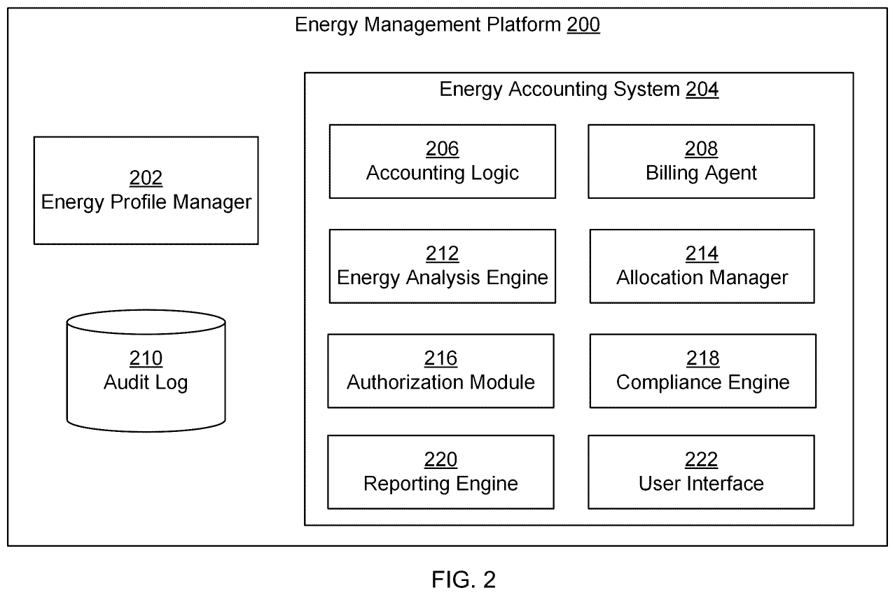

The user devices 106 may enable the energy consumers 104 to access the energy-related transactions, audit logs, reports; receive notifications, recommendations; make informed decisions regarding energy management, and so forth. Further, the user devices 106 may enable the energy consumers 104 to initiate, cease, monitor, regulate, and/or optimize the energy-related transactions. The user devices 106 may enable the energy consumers 104 to communicate with the computing environment 100 to enable seamless integration with the energy accounting, prediction, and/or certification processes. The one or more user devices 106 may include a user interface 222 (as shown in FIG. 2) for communication and/or interaction. The working and functioning of the user interface 222 may be explained in detail in the forthcoming description of the FIG. 2.

Further, the user devices 106 may include one or more software applications (not shown) such as an energy accounting application, an e-commerce application, a location-based service application, a navigation application, a camera/imaging application, an Optical Character Recognition (OCR) application, a media player application, a social networking application, and the like.

In an embodiment of the present invention, the one or more entities may include one or more energy storage facilities 108. The energy storage facilities 108 may be, for example, battery storage systems, pumped hydro storage facilities, flywheels, Compressed Air Energy Storage (CAES), thermal storage units, supercapacitors, gravity-based storage systems, hydrogen-based storage, Liquid Air Energy Storage (LAES), electrochemical storage, thermochemical energy storage, synthetic fuel storage, cryogenic energy storage, and so forth. Embodiments may be intended to include or otherwise cover any suitable type of the energy storage facilities 108, including known, related art, and/or later developed technologies.

According to the embodiments of the present invention, the energy storage facilities 108 may be configured to operate dynamically as either the energy sources 102 or the energy consumers 104 based on real-time demand and/or supply conditions within the computing environment 100. For example, when energy supply exceeds demand, the energy storage facilities 108 may operate as energy consumers 104 by storing surplus energy. Conversely, during periods of high demand or limited supply, the energy storage facilities 108 may act as energy sources 102 by discharging stored energy back to the grid or to the one or more energy consumers 104. An operational mode and/or an energy flow direction of the energy storage facilities 108 may be controlled by an energy management platform 110, according to some embodiments of the present invention.

In an embodiment of the present invention, the computing environment 100 may further include the energy management platform 110. In an embodiment of the present invention, the energy management platform 110 may be a software application stored in a server (not shown). In another embodiment of the present invention, the energy management platform 110 may be implemented as a hardware, a firmware, a software, or a combination thereof, managed by a third-party service provider.

According to an embodiment of the present invention, the energy management platform 110 may be configured to integrate with the one or more energy-associated machines of the energy source 102. In another embodiment of the present invention, the energy management platform 110 may be integrated with the one or more energy-associated machines of the energy consumers 104. In a further embodiment of the present invention, the energy management platform 110 may be deployed on the server that may be a cloud server, an edge computing server, a remote server, a local server, a third-party server, and so forth. Embodiments may be intended to include or otherwise cover any suitable type of the server, including known, related art, and/or later developed technologies.

According to the embodiments of the present invention, the energy management platform 110 may be configured to enable the energy-related transactions among the one or more energy sources 102, the energy consumers 104, and the energy storage facilities 108. Components and the working of the energy management platform 110 may be described in detail in conjunction with the FIG. 2.

Further, the computing environment 100 may include a network 112. According to the embodiments of the present invention, the network 112 may enable communication and data exchange across various energy management platform users, participants, and components of the computing environment 100.

The network 112 may include a data network such as the Internet, Local Area Network (LAN), Wide Area Network (WAN), Metropolitan Area Network (MAN), etc. In certain embodiments of the present invention, the network 112 may include a wireless network, such as, a cellular network, and may employ various technologies including Enhanced Data Rates For Global Evolution (EDGE), General Packet Radio Service (GPRS), Global System For Mobile Communications (GSM), Internet Protocol Multimedia Subsystem (IMS), Universal Mobile Telecommunications System (UMTS) etc. In some embodiments of the present invention, the network 112 may include or otherwise cover networks or sub-networks, each of which may include, for example, a wired or wireless data pathway. The network 112 may include a circuit-switched voice network, a packet-switched data network, or any other network capable of carrying electronic communications. For example, the network 112 may include networks based on the Internet Protocol (IP) or Asynchronous Transfer Mode (ATM), and may support voice usage, for example, VoIP, Voice-over-ATM, or other comparable protocols used for voice data communications.

Examples of the network 112 may further include a Personal Area Network (PAN), a Storage Area Network (SAN), a Home Area Network (HAN), a Campus Area Network (CAN), a Local Area Network (LAN), a Wide Area Network (WAN), a Metropolitan Area Network (MAN), a Virtual Private Network (VPN), an Enterprise Private Network (EPN), the Internet, a Global Area Network (GAN), and so forth. Embodiments are intended to include or otherwise cover any suitable type of the network 112, including known, related art, and/or later developed technologies to connect the components of the computing environment 100 with each other.

FIG. 2 depicts an exemplary functional block diagram of an energy management platform 200 in accordance with at least one embodiment of the present invention. The energy management platform 200 (FIG. 2) may be an example of the energy management platform 110 (FIG. 1). According to the embodiments of the present invention, the energy management platform 200 may include, at least one energy profile manager 202, and at least one energy accounting system 204 that may include at least one accounting logic 206, and at least one billing agent 208.

The energy management platform 200 may further include at least one audit log 210, at least one energy analysis engine 212, at least one allocation manager 214, at least one authorization module 216, at least one compliance engine 218, at least one reporting engine 220, and at least one user interface 222.

At this juncture, it is worthwhile to note that operations around sensitive data, such as with respect to the energy profile manager 202, the energy accounting system 204, and audit logs 210 may be subject to formalized protections. This includes data storage making use of encryption at rest as well as encryption in transit. For persistent data, tamper-proof storage, including but not limited to distributed ledgers such as blockchains may be utilized. User permissions, such as through role based access control to secure authorization to access workflows may be used.

According to at least one embodiment of the present invention, the energy profile manager 202 may be configured to generate one or more energy profiles for the one or more entities based on information received from the one or more entities.

The received information may include energy records for the energies, for example, historical energy consumption data, projected energy requirements, operational schedules, geographic location, type of energy sources used, environmental conditions, one or more business rules, real-time energy allocation requirements, energy generation data, energy storage capacity, real-time energy availability, energy transmission losses, demand-side management metrics, peak demand patterns, maintenance schedules, energy efficiency ratings of equipment, carbon emission targets, energy cost parameters, renewable energy contribution ratios, grid stability parameters, weather forecasts, market energy price fluctuations, load balancing requirements, safety protocols, cybersecurity considerations for energy systems, feedback from previous energy allocation decisions, contractual agreements with energy providers, financial budgets for energy procurement, audit logs of energy usage, regulatory or energy compliance requirements applicable to the respective entities, and so forth. Embodiments of the present invention are intended to include or otherwise cover any suitable type of the information, including known, related art, and/or later developed technologies.

The energy profile manager 202 may further be configured to integrate one or more generated energy profiles with the accounting logic 206 of the energy accounting system 204.

According to at least one embodiment of the present invention, the energy accounting system 204 may be configured to maintain the energy records for the energy-related transactions among the one or more entities. In an embodiment of the present invention, the energy accounting system 204 may be configured to classify the one or more energy-related transactions based on one or more energy-related attributes of the energies. The energy accounting system 204 may be configured to log the one or more classified energy-related transactions in the audit log 210 to maintain a record for energy compliance and monitoring purposes.

The energy accounting system 204 may further be configured to index the logged energy-related transactions based on one or more relevant energy-related attributes of the energies. For instance, the energy accounting system 204 may index the transactions based on the energy provenance, such as the energies derived from renewable energy sources, non-renewable energy sources, hybrid sources, nuclear power plants, Virtual Power Plants (VPPs), and so forth. At another instance, the energy accounting system 204 may index the transactions based on a chain of custody of the energies, which may include aggregated energies, reaggregated energies, disaggregated energies, and so forth. At yet another instance, the energy accounting system 204 may index the transactions based on a combination of the one or more energy-related attributes to enable a comprehensive traceability of the energy-related transactions.

According to at least one embodiment of the present invention, the energy accounting system 204 may be configured to structure and log the energy-related transactions based on the accounting logic 206. The accounting logic 206 may be configured to apply predefined rules and/or algorithms for categorizing, classifying, and/or evaluating energy-related transactions. For instance, the one or more energies corresponding to the logged energy-related transactions may be tracked for their corresponding energy provenances, including renewable energy sources, non-renewable energy sources, hybrid energy sources, and so forth. The accounting logic 206 may further be configured to enable traceability by indexing energy transactions based on attributes such as energy type, the chain of custody, and/or allocation criteria. Such indexing may assist in ensuring energy compliance with regulatory requirements, facilitating audits, and optimizing energy allocation strategies.

According to at least one embodiment of the present invention, the billing agent 208 may be configured to generate one or more energy billing products based on the allocation of the one or more energies to the one or more entities.

According to at least one embodiment of the present invention, the billing agent 208 may be configured to generate one or more energy billing products based on the allocation of the one or more energies to the one or more entities. The billing products may include, for example, invoices, fiat currency transactions, transaction receipts, usage summaries, cost breakdowns by energy source, energy credit adjustments, subscription-based billing statements, tiered pricing reports, tax-related deductions, penalty or surcharge statements, dynamic pricing adjustments, energy balance alerts, and so forth. Embodiments of the present invention are intended to include or otherwise cover any suitable type of the billing products, including known, related art, and/or later developed technologies.

The billing agent 208 may further be configured to manage energy-related financial transactions by adding credits into the account of the energy supplier and deducting credits from the account of the energy consumer upon completion of an energy allocation or transaction.

Additionally, the billing agent 208 may further be configured to customize billing processes and outputs based on billing preferences of the energy management platform users. The billing preferences may include currency type for transactions, periodicity of billing cycles, preferred formats for invoices or receipts, inclusion of detailed cost analyses, notification preferences for billing updates, integration with external accounting systems, adjustments for energy usage thresholds, and so forth. Embodiments of the present invention are intended to include or otherwise cover any suitable type of the billing preferences, including known, related art, and/or later developed technologies.

According to at least one embodiment of the present invention, the audit log 210 may be configured to record, track, and/or store detailed records of all energy-related transactions. The stored energy-related transactions may include transaction timestamps, classification of energy-related attributes, the allocation details, any exceptions or overrides performed during the energy allocation process, and so forth. The audit log 210 may be implemented using a secure, tamper-proof database, such as a relational database (e.g., SQL) or a distributed ledger system (e.g., blockchain), according to an embodiment of the present invention.

Additionally, the audit log 210 may support hierarchical storage formats, including structured logs for quick retrieval, unstructured logs for comprehensive analysis, and time-series databases for tracking temporal trends in energy allocation.

According to at least one embodiment of the present invention, the energy analysis engine 212 may be configured to analyze the energy-related attributes of the received energy records of the energies from the one or more entities. For instance, the energy analysis engine 212 may be configured to identify the type of the energy sources corresponding to the received energies such as whether the energies may be produced through a nuclear power plant, a virtual power plant, or from some other energy sources.

According to at least one embodiment of the present invention, the allocation manager 214 may be configured to receive inputs from the energy profile manager 202 and the energy analysis engine 212. The inputs received from the energy profile manager 202 may include the energy profiles of the one or more entities, allocation preferences, specific constraints configured by the entities, the one or more business rules, and so forth. The inputs received from the energy analysis engine 212 may include details of energy-related attributes such as the type of energy source, energy availability, energy compliance with business rules, feasibility of allocation based on the energy-related attributes, and so forth.

The allocation manager 214 may further be configured to manage the allocation of the energies to the one or more entities in adherence to the one or more business rules. According to the embodiments of the present invention, the business rule may be defined as one or more predefined conditions, one or more restrictions, or one or more guidelines associated with the energy allocation, an energy utilization, or a selection of the energy resources, configured by an entity to meet specific operational, regulatory, or strategic requirements.

In some embodiments of the present invention, the business rule may correspond to jurisdiction-based restrictions. For example, some entities may avoid energy resources originating from specific jurisdictions due to regulatory concerns, trade restrictions, or geopolitical conflicts. In one example, an entity may prohibit energy sourced from a jurisdiction that does not comply with international trade agreements. In some embodiments of the present invention, the business rule may correspond to energy provenance-based restrictions. For example, some entities may restrict energy resources originating from specific regions or supply chains that fail to meet ethical or environmental energy standards. In one example, an entity may avoid energy sourced from regions known for human rights violations or unsustainable practices.

In some embodiments of the present invention, the business rule may correspond to source-based restrictions. For example, some entities may prohibit energy resources generated from specific sources, such as nuclear reactors or non-renewable energy plants. In one example, an entity may restrict energy allocation from coal-fired plants, preferring renewable sources such as solar or wind energy. In some embodiments of the present invention, the business rule may correspond to cost-based restrictions. For example, some entities may limit energy allocation to resources with a cost per unit below a predefined threshold. In one example, an entity may allocate energy only if the cost per kilowatt-hour (kWh) may be below a predetermined value, such as $0.10.

In some embodiments of the present invention, the business rule may correspond to prioritization of renewable energy resources. For example, some entities may configure the energy management platform to prioritize the allocation of energy generated from renewable sources, such as wind, solar, or hydropower, over non-renewable sources. In some embodiments of the present invention, the business rule may correspond to time-based restrictions. For example, some entities may define preferences for energy allocation based on peak or non-peak hours to optimize operational costs. In one example, an entity may allocate energy from high-cost resources only during non-peak hours to reduce expenses.

In a further embodiment of the present invention, the allocation manager 214 may further be configured to fetch one or more prioritization policies for enabling the energy allocation of the energy resources to the entities. The one or more prioritization policies may include energy usage priority levels such as critical, high, medium, and low priority levels. The one or more prioritization policies may further include a business rule compliance based on regulatory or contractual obligations, energy efficiency ratings of the entities, renewable energy sourcing preferences, peak demand management guidelines, environmental impact considerations such as carbon reduction targets, time-sensitive energy allocation based on real-time requirements or operational schedules, financial constraints such as cost caps or budget limits, emergency or contingency policies prioritizing critical operations during grid instability, and so forth. Embodiments of the present invention are intended to include or otherwise cover any suitable prioritization policies, including known, related art, and/or later developed technologies.

The allocation manager 214 may be configured to store an allocation data corresponding to the allocated energies in the audit log 210 for traceability and/or audit purposes. The allocation manager 214 may further be configured to resolve conflicts arising from multiple allocation requests by applying one or more prioritization policies. Further, the allocation manager 214 may be configured to detect anomalies in the energy data, such as discrepancies in the allocation or distribution of the energies.

The allocation manager 214 may further be configured to detect anomalies within the energy data and/or the energy allocations, including discrepancies in the allocation, distribution, or usage of the energies. For example, the allocation manager 214 may further be configured to automate checks to determine whether a power output is consistent with an expected performance of the energy sources or not. This may involve monitoring an operational efficiency of the Virtual Power Plants (VPPs), by identifying signs of slow degradation over time, detecting any mismatches between energy production and utilization, and/or flagging unaccounted spikes in energy generation or consumption. Such anomalies may signal operational inefficiencies or potential faults in the operations of the energy resources. The allocation manager 214 may further be configured to transmit anomaly data of the detected anomalies to the reporting engine 220.

The anomaly data may include data related to energy imbalances, unexpected energy quality variations, mismatches between allocated and consumed energy, unauthorized energy sources, deviations from predicted load profiles, instances of energy theft, delayed energy deliveries, discrepancies in billing data, abnormal fluctuations in transmission losses, and so forth. Embodiments of the present invention are intended to include or otherwise cover any suitable anomaly data, including known, related art, and/or later developed technologies.

According to at least one embodiment of the present invention, the authorization module 216 may be configured to allow an authorized personnel to override the detected business rules under specific circumstances to enable a flexibility in managing the energy allocation while maintaining accountability. For instance, in a scenario where renewable energy sources may not be sufficient to meet immediate operational requirements, an authorized personnel may override the business rule prioritizing renewable sources and may temporarily allocate an energy from non-renewable sources such as a natural gas plant.

At one instance, if an entity ‘ABC’ may have restricted the energy allocation from a nuclear energy source in the business rule that may be fetched by the energy profile manager 202, the authorization module 216 may permit an override of the business rule under specific circumstances. However, under a high-priority allocation requirement, such as when critical infrastructure like hospitals or data centers may need uninterrupted energy during peak demand and/or emergency situations, the authorization module 216 may be configured to share an alert notification to inform the relevant stakeholders. Upon receiving the authorization input from the authorized personnel corresponding to the entity ‘ABC’, the authorization module 216 may be configured to generate an override signal that may allow the energy allocation from the nuclear energy source, even if the business rule may have restricted its use.

At another instance, an entity ‘PQR’ has defined business rules imposing jurisdictional restrictions on energy allocation such as limiting the use of hydroelectric energy generated from a dam located in one jurisdiction for distribution to another jurisdiction. These jurisdictional restrictions may be fetched by the energy profile manager 202. For example, under the business rules, the hydroelectric energy generated from a river dam in a Region ‘A’ may be reserved exclusively for the Region ‘A’ and restricted from distribution to a Region ‘B’. However, under a high-priority allocation requirement, such as when critical infrastructure like transportation hubs or emergency shelters in the Region ‘B’ face an urgent energy shortage, the authorization module 216 may be configured to share an alert notification with the authorized personnel corresponding to the entity ‘PQR’. Upon receiving the authorization input, the override signal may allow the energy allocation to the Region ‘B’, even if the defined jurisdictional restrictions under the business rules had restricted the energy allocation from a hydroelectric energy source of the Region ‘A’.

The allocation of the energies upon overriding of the business rules may be logged in the audit log 210 along with a justification, the transaction timestamps, and personnel details for tracking, auditing, and/or accountability of the energy-related transactions.

According to at least one embodiment of the present invention, the compliance engine 218 may be configured to enable an adherence to jurisdictional regulatory requirements associated with the energy allocation and/or usage. The compliance engine 218 may be configured to dynamically validate allocation processes of the energies to the one or more entities. In an embodiment of the present invention, the compliance engine 218 may be configured to verify an adherence to the allocation of the one or more energies to regulatory requirements associated with the jurisdiction of the corresponding energy source.

For instance, in the case of the nuclear energy, the compliance engine 218 may be configured to verify that the allocation of energy from a nuclear power plant may comply with jurisdictional regulations governing nuclear energy usage. These regulations may include restrictions on an amount of the nuclear energy that may be allocated, radiation monitoring protocols, safety related energy standards that must be met, and so forth.

The compliance engine 218 may further be configured to fetch energy compliance data from relevant regulatory bodies, government agencies, industry related energy standards, and so forth, to verify that energy allocations are in full compliance. For instance, the compliance engine 218 may be configured to enable that the energy allocation may comply with carbon emission regulations specific to a particular region by validating that the allocated energy mix may include a minimum percentage of renewable energy sources, such as 50% solar or wind energy, in jurisdictions with stringent environmental policies of the region. In another example, the compliance engine 218 may verify that energy allocations do not violate export restrictions by cross-referencing the energy provenance with jurisdictional trade agreements.

According to at least one embodiment of the present invention, the reporting engine 220 may be configured to generate energy allocation reports for the one or more entities and/or other stakeholders. The generated energy allocation reports may include allocation summaries, usage analytics, insights into energy efficiency, peak demand trends, cost-saving opportunities, carbon emission statistics, energy source distribution analysis, renewable energy contribution ratios, energy wastage identification, operational performance benchmarks, energy compliance status with regulatory energy standards, grid stability metrics, energy storage utilization summaries, real-time energy consumption patterns, demand-response analysis, lifecycle energy usage projections, comparative energy performance across similar entities, a historical energy trend analysis, maintenance schedule impacts, energy loss statistics, financial expenditure on energy procurement, and so forth. Embodiments of the present invention are intended to include or otherwise cover any suitable energy data in the generated energy allocation reports, including known, related art, and/or later developed technologies.

In an embodiment of the present invention, the reporting engine 220 may further be configured to generate one or more reports based on user preferences. The reporting engine 220 may be configured to enable the one or more entities to select a type of the report to be generated. Further, the reporting engine 220 may be configured to customize the generated reports according to the user preferences.

The generated reports may be of any suitable type such as a Sustainable Development Goal (SDG) compliance report, a carbon net zero report, an energy allocation efficiency report, a renewable energy contribution report, a carbon offset report, an environmental impact assessment report, an energy demand forecasting report, a real-time energy allocation report, an energy cost optimization report, a regulatory compliance assessment report, a safety audit report, a cybersecurity risk report for energy systems, a business rule compliance report, a financial energy impact summary, a stakeholder engagement report, a greenhouse gas emissions inventory, a grid impact analysis report, a market energy price trend report, a supply chain energy usage report, a load balancing effectiveness report, and so forth. Embodiments of the present invention may be intended to cover any suitable type of the reports, including known, related art, and/or later developed technologies.

Further, the reporting engine 220 may be configured to enable the energy consumers 104 to access the generated reports in a user selected format of the report. The user-selected format may be, a read-only text, a Microsoft Word document (Word), a Portable Document Format (PDF), an animated presentation, a video summary, an interactive chart, a display banner, a social media leaflet, a mobile application widget, an augmented reality (AR) visualization, a virtual reality (VR) simulation, a spreadsheet with editable data (e.g., Microsoft Excel), a cloud-based interactive dashboard, an infographic, a podcast or audio summary, a holographic projection, an energy usage map overlay, a timeline-based animation, a live-stream-able report, a QR code linked summary, an energy allocation badge or certificate, a secure email attachment, a printed booklet, a digital flipbook, an energy compliance certificate template, a technical white paper, a customizable report template, a gamified energy tracker interface, and so forth. Embodiments of the present invention may be intended to cover any suitable format for accessing the generated reports, including known, related art, and/or later developed technologies.

In an embodiment of the present invention, the user interface 222 of the energy management platform 200 may be configured on user devices (e.g., the user devices 106) for providing real-time access to one or more of the energy consumption data, a system status, the predictions and the recommendations, one or more generated reports, and so forth, that may be generated by the energy management platform 200. The user interface 222 may be configured to feature interactive elements, such as graphs, charts, visuals, and alerts to facilitate easy interpretation of the energy-related transactions and the flow of energies in the computing environment 100.

The user interface 222 may enable the one or more entities to interact and/or provide user inputs to the energy management platform 200. According to an embodiment of the present invention, the user interface 222 may be customized for different types of the energy management platform users including the energy providers, the energy consumers, energy management platform administrators, and so forth. In an embodiment of the present invention, the user interface 222 may be a Command Line Interface (CLI), a Graphical User Interface (GUI), and so forth. Embodiments of the present invention may be intended to include or otherwise cover any suitable type of the user interface 222, including known, related art, and/or later developed technologies.

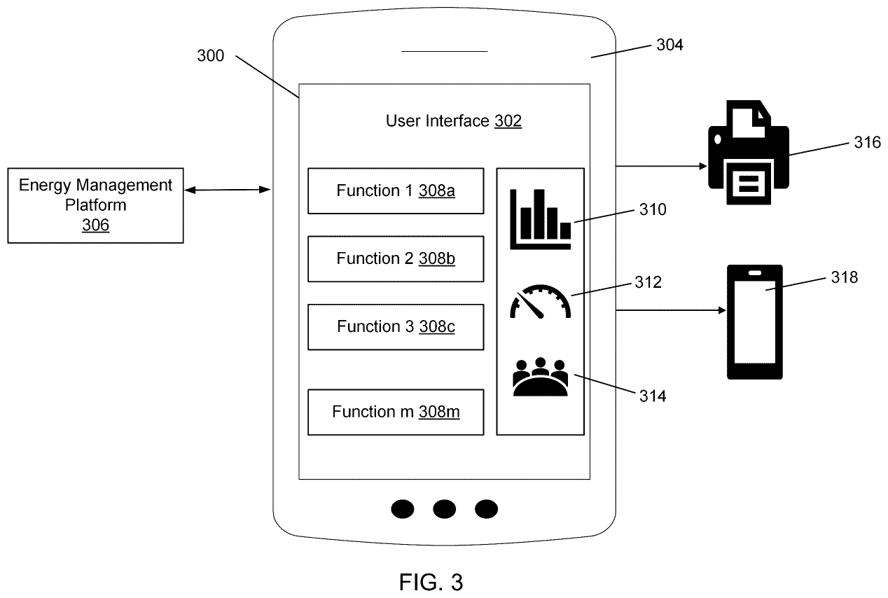

FIG. 3 depicts a block diagram of a user interface 302 of an energy management application 300, in accordance with at least one embodiment of the present invention. In an embodiment of the present invention, the energy management application 300 may be configured to install on a user device 304. The user device 304 (FIG. 3) may an example of the user devices 106a-106o (FIG. 1). The energy management application 300 may allow the energy management platform user to interact with an energy management platform 306. The energy management platform 306 (FIG. 3) may be an example of the energy management platform 110 (FIG. 1).

The energy management application 300 may include a plurality of user consoles that may be configured to enable the energy management platform user to select, view and/or perform a plurality of functions 308a-308n of the energy management platform 306 through the user interface 302. For example, the user interface 302 may include a first function 308a that may be configured to enable the energy management platform user to submit a request for the energy allocation requirement. The user interface 302 may include a second function 308b that may enable the energy management platform user to log one or more business rules along with the energy allocation requirement. The user interface 302 may include a third function 308c that may enable the energy management platform user to view and/or conclude generated billing products, invoices, reconciliation reports, cost breakdowns, and alike. Further, the user interface 302 may include a mth function 308mthat may enable the energy management platform user to view analysis of the products such as detailed consumption trends, predictive analytics, recommendations, and so forth.

Moreover, the user interface 302 may enable the energy management platform user to view and/or analyze energy-related insights through an analysis dashboard 310. For example, the analysis dashboard 310 may be configured to display forecasts of energy demand during peak and slow hours, trends in energy pricing, and efficiency metrics of the one or more energy resources, and so forth. The user interface 302 may further provide recommendations for optimizing energy utilization, such as load balancing strategies, demand response actions, or renewable energy integration measures. The user interface 302 may be configured to include visualization tools that may be configured to display the energy data to the energy management platform user. The visualization tools may include graphs, charts, heat maps, tables, and so forth that dynamically update to reflect real-time energy usage patterns and forecasts.

The user interface 302 may further include an activity clock 312 to enable the user to view time related data such as peak hours, slowdown hours, a timeline for the energy allocation, a pre-configured energy-related transaction, and so forth. The user interface 302 may further be configured to support configurable alerts and notifications to inform the user about critical events, such as unexpected energy surges, equipment failures, or regulatory energy compliance deadlines. The user interface 302 may further include a resource segment 314 to enable the energy management platform user to view and/or select from the available energy resources and/or the entities through the user device 304.

The user interface 302 may further be configured to enable the energy management platform user to share the energy data and/or outputs with an external peripheral device 316. The external peripheral device 316 may include, for example, a printer, a scanner, a storage device, or other similar devices capable of receiving and processing the shared data. Embodiments of the present invention may be intended to include or otherwise cover any suitable external peripheral device 316, including known, related art, and/or later developed technologies.

For example, the energy management platform user may transmit detailed energy consumption reports, the invoices, and/or analytics graphs to a printer for physical documentation and/or to the storage device for archival purposes. The user interface 302 may also be configured to enable the energy management platform user to share the energy data and/or the outputs with an external user device 318. The external user device 318 may include devices such as a laptop, a tablet, a smartphone, and so forth. Embodiments of the present invention may be intended to include or otherwise cover any suitable external user device 318, including known, related art, and/or later developed technologies.

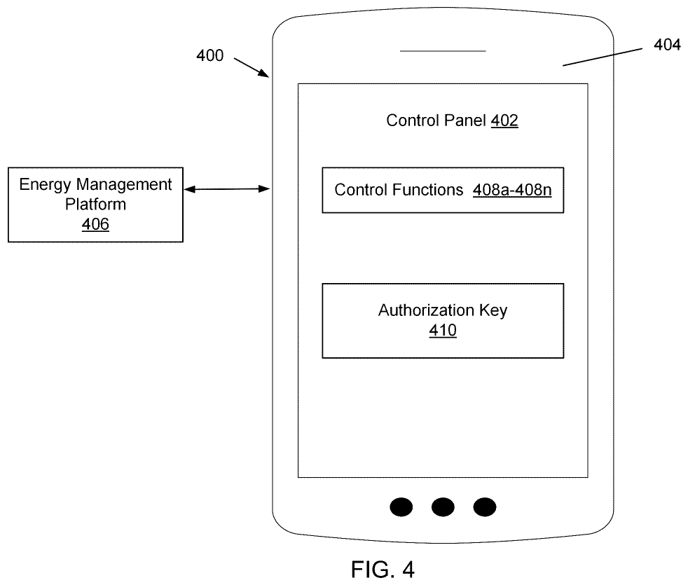

FIG. 4 is an exemplary block diagram of a control panel 402 of an energy management application 400 in accordance with at least one embodiment of the present invention. In an embodiment of the present invention, the energy management application 400 may be configured to install on a user device 404. The user device 404 (FIG. 4) may an example of the user devices 106a-106o (FIG. 1). The energy management application 400 may allow the energy management platform user to interact with an energy management platform 406. The energy management platform 406 (FIG. 4) may be an example of the energy management platform 110 (FIG. 1).

The energy management application 400 may include a plurality of admin consoles that may be configured to enable the authorized personnel to select, view, modify, and/or perform a plurality of control functions 408a-408n of the energy management platform 406 through the control panel 402. For example, the control panel 402 may include a first control function 408a that may be configured to enable the authorized personnel to submit and/or modify requests for the energy allocation requirement. The control panel 402 may include a second control function 408b that may enable the authorized personnel to log and/or modify the business rules along with the energy allocation requirement. The control panel 402 may include a third control function 408b that may enable the authorized personnel to view, modify and/or conclude the generated billing products, invoices, reconciliation reports, cost breakdowns and alike. Further, the control panel 402 may include an nth control function 408n that may enable the authorized personnel to view and/or modify the analysis products such as the detailed consumption trends, the predictive analytics, the recommendations, and so forth.

The control panel 402 may further include an authorization key 410, in an embodiment of the present invention. The authorization key 410 may be configured to enable the authorized personnel to override a logged business rule under specific conditions. Upon selection, the authorization key 410 may be configured to transmit the override signal to an authorization module (e.g., the authorization module 216) of the energy management platform 406.

For instance, when an authorized personnel selects the authorization key 410 through the control panel 402, the authorization key 410 may be configured to generate an override signal that may be a secure and/or encrypted signal and may be transmitted to the authorization module of the energy management platform 406. The authorization module may then validate the received override signal. Once validated, the authorization module may then be configured to execute the override by temporarily modifying and/or bypassing the logged business rule. For example, in a situation where the business rule restricts the energy allocation from a nuclear energy source, such as a natural gas plant, the override may permit an energy to be allocated from the nuclear energy source to meet immediate operational requirements, such as providing uninterrupted energy to critical infrastructure like hospitals and/or data centers during emergencies.

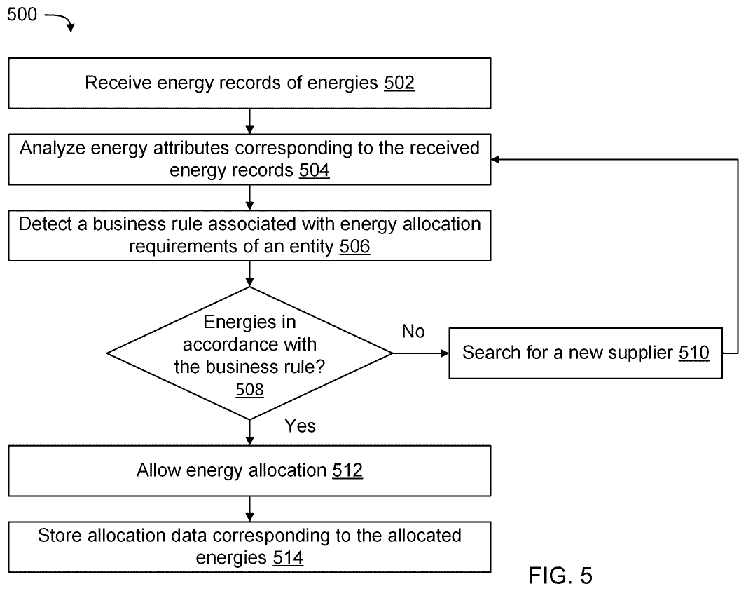

FIGS. 5-9 present illustrative one or more processes 500-900 for implementing energy accounting systems in accordance with at least one embodiment of the present invention. The one or more processes 500-900 may be illustrated as a collection of blocks in a logical flowchart, which represents a sequence of operations that may be implemented in hardware, software, or a combination thereof. In the context of software, the blocks represent computer-executable instructions that, when executed by one or more processors, perform the recited operations. Generally, computer-executable instructions may include routines, programs, objects, components, data structures, and the like that perform particular functions or implement particular abstract data types. The order in which the operations may be described may not be intended to be construed as a limitation, and any suitable number of the described blocks may be combined in any suitable order and/or in parallel to implement the process.

FIG. 5 is an exemplary process 500 of allocating energies using an energy management platform in accordance with at least one embodiment of the present invention.

At 502 block, the energy management platform may be configured to receive the records of the energies from the one or more entities. The received energy records may include the energy-related attributes that may be fetched from the one or more entities by the energy profile manager, according to an embodiment of the present invention. The received energy records can also be correlated with telemetry from the energy sources 102.

At 504 block, the energy management platform may be configured to analyze the fetched energy-related attributes corresponding to the received energy records and/or the received telemetry from the energy sources 102. The fetched energy-related attributes corresponding to the received energy records may be logged in to the audit log.

At the 506 block, the energy management platform may be configured to detect one or more business rule associated with energy allocation requirements of an entity. The energy management platform may be configured to enable the entity to provide the energy allocation requirements through the user device. The energy management platform may be configured to enable the entity to provide and/or the business rule for the allocation of the energies along with the energy allocation requirements through the user device, as well as telemetry from an energy source 102.

At the 508 block, the energy management platform may be configured to detect whether the energies may be in accordance with the detected business rule as set by the entity or not. For instance, the energy management platform may be configured to detect whether the energies may be from an unrestricted jurisdiction and/or from an unrestricted energy provenance. If the received energies are in accordance with the detected business rule, the process 500 may proceed to a 512 block, otherwise the process 500 may proceed to a 510 block.

At the 510 block, the energy management platform may search for a new energy supplier and/or the energy storage facility. Upon searching, the process 500 may return to the 504 block and continue to analyze the energy-related attributes.

At the 512 block, the energy management platform may allow the energy allocation to the entity.

At 514 block, the energy management platform may be configured to store the allocation data corresponding to the allocated energies to the entity in the audit log. The stored allocation data may be fetched by the components of the energy management platform 110 for generating billing products, the energy allocation reports, predictive recommendations, detecting the anomalies, and so forth. Embodiments of the present invention may be intended to include or otherwise cover any suitable application of the stored allocation data, including known, related art, and/or later developed technologies.

At this juncture, it may be worthwhile to describe some illustrative and non-limiting examples of business rules and their application to the energy management system. A first example is asset lifecycle management. Expected behavior and expected performance around key energy assets including energy sources 102 (such as batteries, inverters, and solar panels) can be codified as business rules. Specifically a business rule can define an expected operational range and in block 508 trigger alerts and other interventions if the actual telemetry shows that an operation is out of that expected range. Business rules can include interventions such as recommendations to perform predictive and proactive maintenance, make use of cost modeling to ensure return on investment in the key energy assets, and provide data to support depreciation.

A second example is carbon intensity and environmental social governance (ESG) scoring. Presently, energy consumers 104 may be companies which in turn may have communicated ESG policies, including carbon policies to shareholders. One example includes greenhouse gas emission reporting such as scope 1, 2, and 3 emissions reporting. The collected energy records correlated to collected telemetry from energy sources 102 can be used to estimate carbon emissions and intensity and detect whether that carbon activity is within the ranges represented by the ESG policy. In block 508 the energy management system may trigger alerts and make intervention recommendations if carbon activity is out of ESG policy range.

A third example is tariff and pricing flexibility. In some jurisdictions, the time of day of energy utilization impacts the price of that energy. For example at peak times, utilities may charge tariffs that make energy more expensive. In block 510, recommendations to seek alternative sourcing may be triggered by making use of tariff information, including time-of-use, real time pricing, and pricing tiers for energy utilization.

A fourth example is dynamic market participation. Variations in actual prices and expected prices, for example due to tariffs, in block 510 can trigger recommendations to seek alternative sourcing of energy. Alternative sourcing can include participation in grid services or peer-to-peer virtual power plant trading. As this alternative sourcing of energy involves offers and bids, in block 510, the energy management system may interface with an energy trading system to participate in such alternative sourcing.

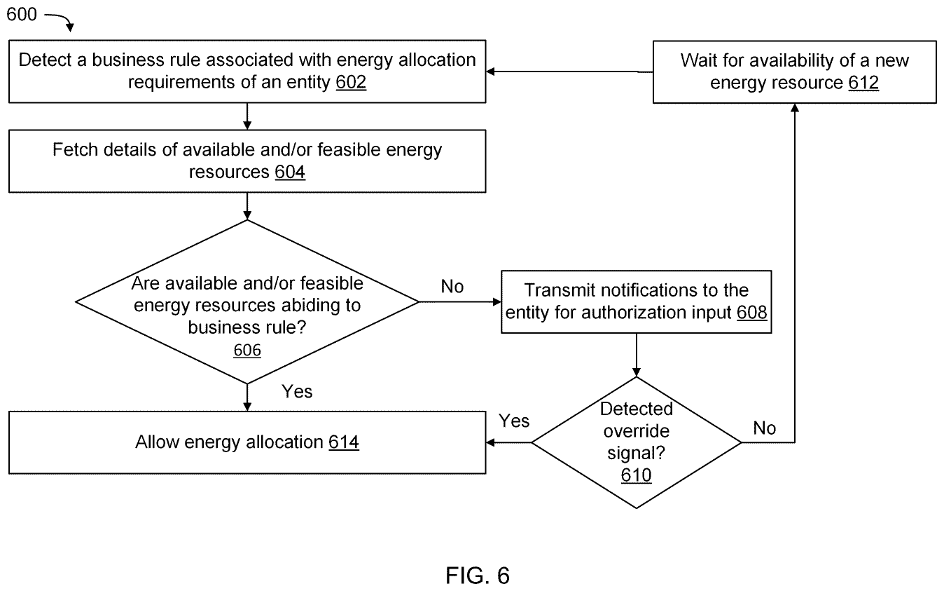

FIG. 6 is an exemplary process 600 of overriding an energy allocation using the energy management platform in accordance with at least one embodiment of the present invention.

At 602 block, the energy management platform may be configured to detect a business rule associated with an energy allocation requirements of an entity.

At 604 block, the energy management platform may be configured to fetch details of available and/or feasible energy resources.

At 606 block, the energy management platform may be configured to detect whether the available and/or feasible energy resources may be in accordance with the business rule or not. If the available and/or feasible energy resources may not be in accordance with the business rule, the process 600 may proceed to a block 608. Otherwise, the process 600 may proceed to a block 614.

At the 608 block, the energy management platform may be configured to transmit one or more notifications to the entity for an authorization input to override the business rule for allowing the energy allocation from the available and/or feasible energy resources that may not be in accordance with the business rule. The notification may further include a summary of non-compliance issues, the associated risks, and/or an option to proceed with the available resources despite the deviation.

At 610 block, the energy management platform may be configured to detect an override signal in response to the transmitted notification for the authorization input to override the business rule for allowing the energy allocation from the available and/or feasible energy resources that may not be biding the business rule. If a reception of the override signal may not be detected, the process 600 may proceed to a step 612. Otherwise, the process 600 may proceed to the 614 block.

At the 612 block, the energy management platform may be configured to wait for the availability of a new energy resource that is compliant with the business rule. During this waiting period, the energy management platform may be configured to periodically monitor and/or identify any new energy resources from internal or external sources, and upon detecting availability, the process 600 may proceed to the block 602.

At the 614 block, the energy management platform may allow the energy allocation to the entity. The allocation process may include updating resource utilization logs, notifying the entity of the allocation status, and so forth.

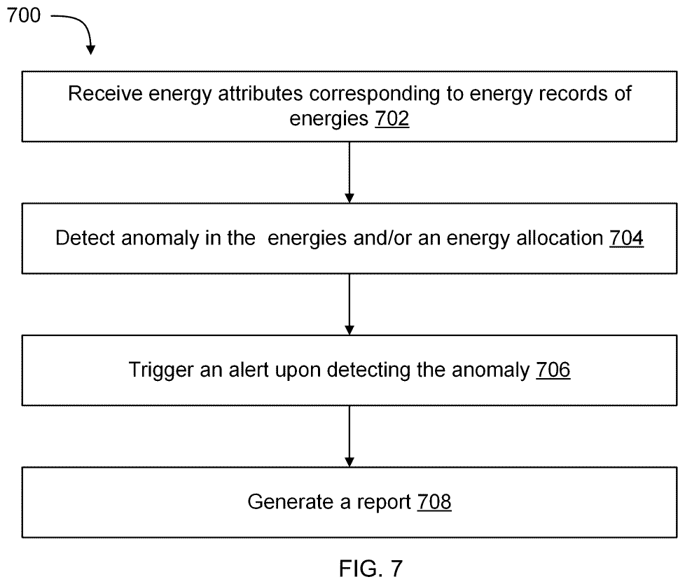

FIG. 7 is an exemplary process 700 of detecting an anomaly in an energy and/or the energy allocation and/or energy sources 102 using the energy management platform in accordance with at least one embodiment of the present invention.

At 702 block, the energy management platform may be configured to receive the energy-related attributes corresponding to the received energy records.

At 704 block, the energy management platform may be configured to detect the anomaly in the energies and/or the energy allocation of the energies based on the received energy-related attributes and/or energy sources 102. The detection process may involve comparing the received energy-related attributes with predefined thresholds, historical patterns, machine-learning-derived baselines, or regulatory energy standards. For example, the anomaly in the energies and/or the energy allocation may include the energy imbalances, the unexpected energy quality variations, the mismatches between the allocated and/or consumed energy, the unauthorized energy sources, the deviations from predicted load profiles, the deviations from expected performance of energy sources 102, the instances of the energy theft, the delayed energy deliveries, the discrepancies in the billing data, the abnormal fluctuations in transmission losses, and so forth. Embodiments of the present invention may be intended to include or otherwise cover any suitable type of the anomaly, including known, related art, and/or later developed technologies. The detection of the anomaly may be executed using advanced analytics, AI-driven predictive models, anomaly detection algorithms, or rule-based systems configured within the energy analysis engine.

At 706 block, the energy management platform may be configured to trigger an alert to the user device upon detecting the anomaly in the received energies and/or the energy allocation of the received energies and/or energy sources 102. The energy management platform may be configured to transmit the alert notification based on the triggered alert. The alert notification may be transmitted to the user device through one or more communication channels, such as an E-mail, a Short Messaging Service (SMS), push notifications, mobile application alerts, web dashboard pop-ups, API callbacks to connected systems, and so forth. Embodiments of the present invention may be intended to include or otherwise cover any suitable type of the communication channels, including known, related art, and/or later developed technologies.

The alert notification may include details such as a nature of the anomaly, affected energy batches, recommended corrective actions, real-time visualizations of the anomaly, and an urgency level (e.g., high, medium, or low). In some embodiments, the alert notification may also include escalation options to notify higher-level stakeholders or external regulatory bodies.

At 708 block, the energy management platform may be configured to generate an anomaly report upon detecting the anomaly in the received energies and/or the energy allocation of the received energies and/or energy sources 102. The anomaly report may include a summary of the detected anomaly, its root cause analysis, potential impacts on energy operations, historical contexts of similar anomalies, recommended preventive measures, and energy compliance considerations. Additionally, the report may feature detailed analytics, visualizations (e.g., graphs, heatmaps, or trend lines), projected financial implications, and recovery action plans. Embodiments of the present invention may be intended to include or otherwise cover any suitable type of anomaly information, including known, related art, and/or later developed technologies. The anomaly report may be generated in customizable formats such as PDF, interactive dashboards, technical documentation, energy compliance audit templates, or real-time data streams integrated with other platforms. Embodiments of the present invention may be intended to include or otherwise cover any suitable format of the anomaly report, including known, related art, and/or later developed technologies.

At this juncture, degradation modeling for solar and battery assets provides an exemplary but non-limiting illustration of the operation of the anomaly detection described with respect to FIG. 7. As the energy management platform receives energy records as per block 702, it can, in block 704 look for deviations of the performance of energy sources 102, such as degradation of solar panels and batteries. For example, each energy source 102 may have an expected degradation over time. In block 706, if the energy source 102 telemetry as reported via the collected records does not match the expected degradation, the energy management system may trigger an alert for investigation. For such investigation, in block 708, the energy management system may generate a report that either via an expert system, or an AI application may make suggested diagnoses of issues and/or recommendations for rectification. In the event that further investigation shows that the health (e.g., operational efficiency) of the energy source 102 is accurate as reported, but the energy source 102 is otherwise operating normally, this information can be used by the energy management system to determine false positives for triggering, and/or to modify recommendations. Additionally, in block 706, the energy management system can determine whether the energy source 102 behavior matches the bill from the utility. If not, in block 708 the energy management system may generate a report that provides the necessary data to challenge the erroneous bill.

The above example simply illustrates one of many possible use cases, here relying primarily on data from energy sources 102. Other use cases are enabled by energy source data, data regarding received energies and/or the energy allocation of the received energies.

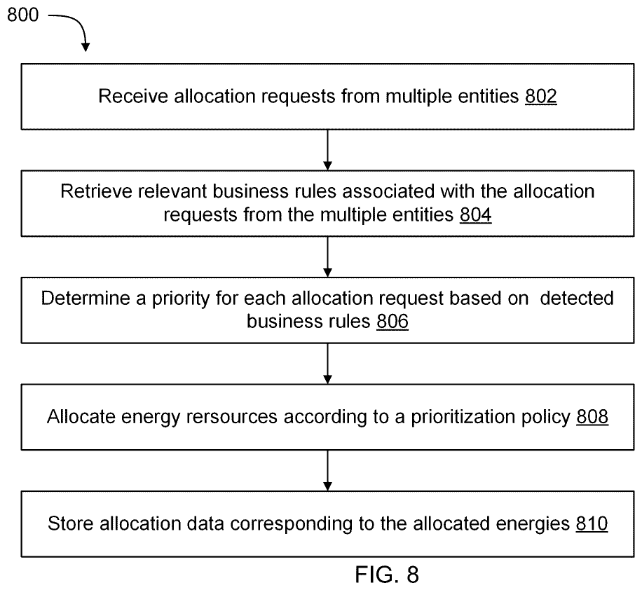

FIG. 8 is an exemplary process 800 of allocation of energies based on a prioritization policy using the energy management platform in accordance with at least one embodiment of the present invention.

At 802 block, the energy management platform may be configured to receive energy allocation requests from the one or more entities. The energy allocation requests may include details such as the requested energy type (e.g., renewable or non-renewable), quantity, priority level, requested timeframe, associated costs, and any specific operational or regulatory requirements. The energy allocation requests may be received via the APIs, the user interface, automated systems integrated with the energy management platform, and so forth.

At 804 block, the energy management platform may be configured to retrieve the business rules associated with the allocation requests from the multiple entities. The business rules may define allocation criteria such as fairness policies, minimum energy thresholds, geographical proximity, jurisdictional restrictions, energy efficiency goals, carbon footprint reduction mandates, and contractual obligations. The business rules may be stored in a dynamic rule repository associated with the energy profile manager. The energy management platform may be configured to enable the one or more entities to update and/or override to the stored business rules, according to an embodiment of the present invention.

At 806 block, the energy management platform may be configured to determine a priority for one or more energy allocation requests based on the detected business rules. The priority determination may include evaluating parameters such as urgency of the one or more energy allocation requests, historical energy usage patterns of the entity, energy compliance requirements, criticality of operations (e.g., hospitals or emergency services), available energy resources, and so forth.

At 808 block, the energy management platform may be configured to allocate energy resources according to the prioritization policy. The allocation process may enable that high-priority requests are fulfilled first, while optimizing the overall resource utilization and minimizing energy wastage. The energy management platform may be configured to support both real-time and batch allocations, with the ability to reallocate the energy resources dynamically in response to changing the priorities and/or emergencies.

At 810 block, the energy management platform may be configured to store the allocation data corresponding to the allocated energies. The stored data may include details of the allocation transactions, such as the entity details, allocated energy quantity, allocation time, source of energy, energy compliance certifications, and cost breakdowns. The allocation data may be stored in the audit log for auditing, reporting, and/or future analysis purposes.

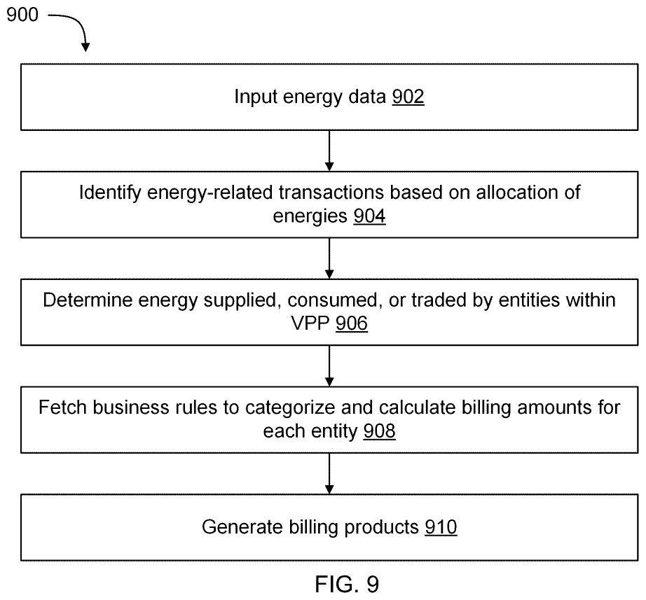

FIG. 9 depicts an exemplary process 900 of generating a billing product using the energy management platform in accordance with at least one embodiment of the present invention.

At 902 block, the energy management platform may be configured to input energy data. The energy data may include details such as the energy allocation data, energy generation data, the energy-related attributes, energy distribution data, energy consumption patterns, energy trading information, time-of-use data, peak hours, and so forth. The energy data may be sourced from the audit log and/or the allocation manager, according to an embodiment of the present invention. In another embodiment of the present invention, the energy data may be sourced from various systems such as smart meters, energy monitoring sensors, the Virtual Power Plants (VPPs), third-party data feeds, and so forth.

At 904 block, the energy management platform may be configured to identify the energy-related transactions based on the allocation of energies. The energy management platform may further be configured to track energy-allied activities such as energy supplied to consumers, energy exchanged among the entities within the VPP, and the energy stored and/or returned to a power grid or a microgrid, and so forth.

At 906 block, the energy management platform may be configured to determine energy supplied, consumed, or traded by entities within the VPP. This determination may include calculating net energy usage, identifying surplus energy shared with the grid, analyzing trading records among the entities, and so forth. The energy management platform may also be configured to employ advanced analytics to validate the accuracy of the energy flows and their corresponding records.

At 908 block, the energy management platform may be configured to fetch the business rules to categorize and/or calculate billing amounts for respective to the one or more entities. The business rules may include pricing models such as time-of-use pricing, flat rates, tiered pricing, taxes, regulatory energy compliance fees, incentives for green energy usage, and so forth. The energy management platform may be configured to apply the business rules to accurately categorize the energy usage and/or compute billing amounts for one or more participating entities.

At 910 block, the energy management platform may be configured to generate billing products by utilizing the billing agent of the energy accounting system. The billing products may include detailed invoices, summary statements, usage reports, tax compliance documents, and payment reminders. The billing products may be customized based on the user preferences and/or may be delivered in multiple formats such as PDF, interactive web portals, system-integrated APIs, and so forth. The energy management platform may also be configured to support automated delivery of the billing products to stakeholders and integration with payment systems.

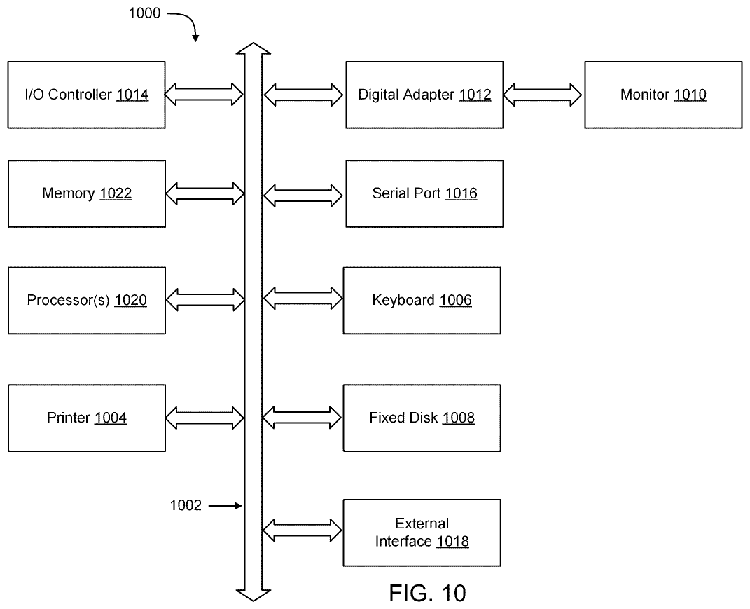

FIG. 10 is a schematic diagram illustrating aspects of an example computer in accordance with at least one embodiment of the present invention. In accordance with at least some embodiments, the system, apparatus, methods, processes and/or operations for message coding may be wholly or partially implemented in the form of a set of instructions executed by one or more programmed computer processors such as a central processing unit (CPU) or microprocessor. Such processors may be incorporated in an apparatus, server, client or other computing device operated by, or in communication with, other components of the system.

As an example, the FIG. 10 depicts aspects of elements that may be present in a computer device and/or system 1000 configured to implement a method and/or process in accordance with some embodiments of the present invention. The subsystems shown in FIG. 10 are interconnected via a system bus 1002. Additional subsystems such as a printer 1004, a keyboard 1006, a fixed disk 1008, a monitor 1010, which is coupled to a display adapter 1012. Peripherals and input/output (I/O) devices, which couple to an I/O controller 1014, can be connected to the computer system by any number of means known in the art, such as a serial port 1016. For example, the serial port 1016 or an external interface 1018 can be utilized to connect the computer device 1000 to further devices and/or systems not shown in FIG. 10 including a wide area network such as the Internet, a mouse input device, and/or a scanner. The interconnection via the system bus 1002 allows one or more processors 1020 to communicate with each subsystem and to control the execution of instructions that may be stored in a system memory 1022 and/or the fixed disk 1008, as well as the exchange of information between subsystems. The system memory 1022 and/or the fixed disk 1008 may embody a tangible computer-readable medium.

It should be understood that the present invention as described above can be implemented in the form of control logic using computer software in a modular or integrated manner. Alternatively, or in addition, embodiments of the invention may be implemented partially or entirely in hardware, for example, with one or more circuits such as electronic circuits, optical circuits, analog circuits, digital circuits, integrated circuits (“IC”, sometimes called a “chip”) including application-specific ICs (“ASICs”) and field-programmable gate arrays (“FPGAs”), and suitable combinations thereof. As will be apparent to one of skill in the art, notions of computational complexity and computational efficiency may be applied mutatis mutandis to circuits and/or circuitry that implement computations and/or algorithms. Based on the disclosure and teachings provided herein, a person of ordinary skill in the art will know and appreciate other ways and/or methods to implement the present invention using hardware and/or a combination of hardware and software.

Any of the software components, processes or functions described in this application may be implemented as software code to be executed by a processor using any suitable computer language such as, for example, Java, C++ or Perl using, for example, conventional or object-oriented techniques. The software code may be stored as a series of instructions, or commands on a computer readable medium, such as a random-access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

According to the embodiments of the present invention, the energy management platform may include the one or more processor 1020 and the memory 1020 for storing instructions. In such an embodiment of the present invention, the instructions stored in the memory 1020 may be executed by the memory 1020 to perform a set of operations of the energy management platform.

The instructions may be in the form of packages of a computer program code. The code, for example, may be written in a computer programming language that may be compiled into a native instruction set of the one or more processor 1020. Further, the code may also be written directly using the native instruction set (e.g., machine language) for executing a set of operations. The set of operations may typically include comparing two or more units of information, shifting positions of units of information, and combining two or more units of information, such as by addition or multiplication or logical operations like OR, exclusive OR (XOR), and AND. Each operation of the set of operations that can be performed by the one or more processor 1020 may be represented to the one or more processor 1020 by information called instructions, such as an operation code of one or more digits. A sequence of operations to be executed by the one or more processor 1020, such as a sequence of operation codes, constitutes processor instructions, also called computer system instructions or, simply, computer instructions. The one or more processor 1020 may be implemented as mechanical, electrical, magnetic, optical, chemical, or quantum components, among others, alone or in combination. Embodiments of the present invention may be intended to include or otherwise cover any suitable implementation of the one or more processor 1020, including known, related art, and/or later developed technologies.

The use of the terms “a” and “an” and “the” and similar referents in the specification and in the following claims are to be construed to cover both the singular and the plural, unless otherwise indicated herein or clearly contradicted by context. The terms “having,” “including,” “containing” and similar referents in the specification and in the following claims are to be construed as open-ended terms (e.g., meaning “including, but not limited to,”) unless otherwise noted. Recitation of ranges of values herein are merely intended to serve as a shorthand method of referring individually to each separate value inclusively falling within the range, unless otherwise indicated herein, and each separate value is incorporated into the specification as if it were individually recited herein. All methods described herein can be performed in any suitable order unless otherwise indicated herein or clearly contradicted by context. The use of any and all examples, or exemplary language (e.g., “such as”) provided herein, is intended merely to better illuminate embodiments of the present invention and does not pose a limitation to the scope of the invention unless otherwise claimed. No language in the specification should be construed as indicating any non-claimed element as essential to each embodiment of the present invention.

Different arrangements of the components depicted in the drawings or described above, as well as components and steps not shown or described are possible. Similarly, some features and subcombinations are useful and may be employed without reference to other features and subcombinations. Embodiments of the present invention may have been described for illustrative and not restrictive purposes, and alternative embodiments will become apparent to readers of this patent. Accordingly, the present invention is not limited to the embodiments described above or depicted in the drawings, and various embodiments and modifications can be made without departing from the scope of the claims below.

### CONCLUSION

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. An energy management platform, comprising:
at least one energy profile manager configured to receive one or more energy records of one or more energies from one or more energy sources;
at least one energy analysis engine configured to analyze one or more energy-related attributes corresponding to the one or more energy records received by the at least one energy profile manager; and
an allocation manager configured to:
detect at least one business rule associated with one or more energy allocation requirements of at least one entity; and
allocate the one or more energies corresponding to the one or more received energy records in accordance with the at least one detected business rule.

2. The energy management platform of claim 1, further comprising at least one authorization module configured to enable an override of the at least one detected business rule upon receiving at least one authorization input.

3. The energy management platform of claim 1, wherein the allocation manager is further configured to store allocation data corresponding to the one or more allocated energies in at least one audit log.

4. The energy management platform of claim 1, wherein the at least one energy analysis engine is further configured to identify energy sources as originating from a nuclear power plant or a virtual power plant based on the one or more energy-related attributes.

5. The energy management platform of claim 1, further comprising at least one billing agent configured to generate at least one energy billing product based on the allocation of the one or more energies to the at least one entity.

6. The energy management platform of claim 1, further comprising a compliance engine configured to verify adherence of the allocation of the one or more energies to regulatory requirements associated with at least one jurisdiction of the at least one energy source.

7. The energy management platform of claim 1, wherein the allocation manager is further configured to resolve conflicts between multiple allocation requests by applying at least one prioritization policy based on the at least one detected business rule.

8. The energy management platform of claim 1, further comprising a monitoring engine configured to:
detect at least one anomaly in the one or more energies; and
trigger at least one alert upon detecting the at least one anomaly in the one or more energies.

9. The energy management platform of claim 1, further comprising a reporting engine configured to generate at least one report for benefit of energy allocation analysis based on the allocation of the one or more energies to the at least one entity.

10. A method for managing one or more energies using an energy management platform, comprising:
receiving one or more energy records of the one or more energies from one or more energy sources;
analyzing one or more energy-related attributes corresponding to the one or more received energy records;
detecting at least one business rule associated with one or more energy allocation requirements of at least one entity; and
allocating the one or more energies corresponding to the one or more received energy records in accordance with the at least one detected business rule.

11. The method of claim 10, further comprising enabling an override to the at least one detected business rule upon receiving at least one authorization input.

12. The method of claim 10, further comprising storing allocation data corresponding to the one or more allocated energies in at least one audit log.

13. The method of claim 10, further comprising identifying energy sources as originating from a nuclear power plant or a virtual power plant based on the one or more energy-related attributes.

14. The method of claim 10, further comprising resolving conflicts between multiple allocation requests by applying at least one prioritization policy based on the at least one detected business rule.

15. The method of claim 10, further comprising generating at least one energy billing product using at least one billing agent based at least in part on the allocation of the one or more received energies to the at least one entity.

16. The method of claim 10, further comprising generating at least one report for benefit of energy allocation analysis based on the allocation of the one or more received energies to the at least one entity.

17. The method of claim 10, further comprising:
detecting at least one anomaly in the one or more energies; and
triggering at least one alert upon detecting the at least one anomaly in the one or more energies.

18. One or more computer-readable storage media collectively having thereon computer-executable instructions that, when executed, collectively cause one or more computers to, at least:
receive one or more energy records of one or more energies from one or more energy sources;
analyze one or more energy-related attributes corresponding to the one or more received energy records;
detect at least one business rule associated with one or more energy allocation requirements of at least one entity; and
allocate the one or more received energies corresponding to the one or more received energy records in accordance with the at least one detected business rule.

19. The one or more computer-readable storage media of claim 18, wherein the computer-executable instructions are further configured to at least enable an override to the at least one detected business rule upon receiving an authorization input.

20. The one or more computer-readable storage media of claim 18, wherein the computer-executable instructions are further configured to generate at least one report for benefit of energy allocation analysis based on the allocation of the one or more energies to the at least one entity.
